(19) United States
(12) Patent Application Publication
(10) Pub. No.: US 2015/0373087 A1
(43) Pub. Date: Dec. 24, 2015

(54) COMMUNICATION OF APPLICATION MICROARCHITECTURE ATTRIBUTES BETWEEN DATACENTERS

(71) Applicant: Empire Technology Development LLC, Wilmington, DE (US)

(72) Inventor: Ezekiel Kruglick, Poway, CA (US)

(21) Appl. No.: 14/379,492

(22) PCT Filed: Nov. 6, 2013
(86) PCT No.: PCT/US13/68812

§ 371 Date: Aug. 18, 2014

(51) Int. Cl. H04L 29/08; G06F 9/54

(52) U.S. Cl. CPC H04L 67/10; G06F 9/542

(57) ABSTRACT

Technologies are directed to a communication of application microarchitecture attributes between datacenters. According to some examples, components of a distributed broker are executed at an origin datacenter and a destination datacenter to communicate the microarchitecture attributes of an application executed or being executed at the origin datacenter. The distributed broker may read an event counter register to capture an instruction counter of the application at the origin datacenter. The instruction counter may be added to a microarchitecture instruction census (MIC) at the origin datacenter. The MIC may be combined with an identification information of the application to produce a portable affinity record at the origin datacenter. In addition, the portable affinity record may be transmitted to the destination datacenter from the origin datacenter.

### BACKGROUND

Unless otherwise indicated herein, the materials described in this section are not prior art to the claims in this application and are not admitted to be prior art by inclusion in this section.

Datacenters provide heterogeneous application services to customers. In providing their services, datacenters build administrative libraries to manage application affinity to specific hardware of the datacenter. An administrative library associated with an application may not be portable between datacenters because of hardware differences between datacenters. Datacenters may also vary model and number of their processors, supporting chipsets, memory types, motherboard configurations, and similar hardware resources. A new customer at a new datacenter may therefore be burdened by hindered performance for an application in comparison to a previous datacenter. The new customer may be burdened because of lack of affinity information that inhibits optimized execution of the application at the new datacenter through matching of the application to hardware resources.

### SUMMARY

The present disclosure generally describes techniques for communication of microarchitecture attributes between datacenters.

According to some examples, a method is provided to communicate microarchitecture attributes of an application executed at an origin datacenter to a destination datacenter. An example method may include reading an event counter register to capture an instruction counter of the application, adding the instruction counter to a microarchitecture instruction census (MIC), combining the MIC with an identification information of the application to produce a portable affinity record, and transmitting the portable affinity record to the destination datacenter.

According to other examples, a method is provided to communicate microarchitecture attributes of an application executed at an origin datacenter to a destination datacenter. An example method may include receiving a portable affinity record from the origin datacenter, generating a destination affinity record of an affinity between an identification information of an application and hardware resources based on a microarchitecture instruction census (MIC) in the portable affinity record, and processing the MIC associated with the portable affinity record through an affinity analysis to generate the destination affinity record.

According to other examples, a method is provided to communicate microarchitecture attributes of an application executed at an origin datacenter to a destination datacenter through a distributed broker. An example method may include reading an event counter register to capture an instruction counter of the application at the origin datacenter, adding the instruction counter to a microarchitecture instruction census (MIC) at the origin datacenter, combining the MIC with an identification information of the application to produce a portable affinity record at the origin datacenter, transmitting the portable affinity record to the destination datacenter from the origin datacenter, receiving the portable affinity record at the destination datacenter, generating a destination affinity record of an affinity between an identification information of an application and hardware resources based on the MIC in the portable affinity record at the destination datacenter, and processing the MIC associated with the portable affinity record through an affinity analysis to generate the destination affinity record at the destination datacenter.

According to other examples, a device is provided to communicate microarchitecture attributes of an application executed at an origin datacenter to a destination datacenter through a distributed broker. The device may include the origin datacenter, the destination datacenter, a memory configured to store instructions, and a controller coupled to the memory and configured to execute an instruction census module of the distributed broker. The instruction census module may be configured to read an event counter register to capture an instruction counter of the application at the origin datacenter, add the instruction counter to a microarchitecture instruction census (MIC) at the origin datacenter, combine the MIC with an identification information of the application to produce a portable affinity record at the origin datacenter, transmit the portable affinity record to the destination datacenter from the origin datacenter, receive the portable affinity record at the destination datacenter, generate a destination affinity record of an affinity between an identification information of an application and hardware resources based on the MIC in the portable affinity record at the destination datacenter, and process the MIC associated with the portable affinity record through an affinity analysis to generate the destination affinity record at the destination datacenter.

According to other examples, a computer-readable medium may be provided to communicate microarchitecture attributes of an application executed at an origin datacenter to a destination datacenter through a distributed broker. The instructions may cause a method to be performed in response to execution, the method being similar to the methods described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates example origin and destination datacenters hat may exchange microarchitecture attributes of an application;

FIG. 2 illustrates an example schema of communicating microarchitecture attributes of an application between datacenters;

FIG. 3 illustrates an example origin datacenter configured to communicate microarchitecture attributes of an application;

FIG. 4 illustrates an example destination datacenter configured to receive microarchitecture attributes of an application;

FIG. 5 illustrates a general purpose computing device, which may be used to communicate microarchitecture attributes of an application;

FIG. 6 is a flow diagram illustrating an example method to communicate microarchitecture attributes of an application; and

FIG. 7 illustrates a block diagram of an example computer program product to communicate microarchitecture attributes of an application;

all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to communication of microarchitecture attributes of an application between datacenters.

Briefly stated, technologies are directed to a communication of application microarchitecture attributes between datacenters. According to some examples, components of a distributed broker are executed at an origin datacenter and a destination datacenter to communicate the microarchitecture attributes of an application executed or being executed at the origin datacenter. The distributed broker may read an event counter register to capture an instruction counter of the application at the origin datacenter. The instruction counter may be added to a microarchitecture instruction census (MIC) at the origin datacenter. The MIC may be combined with an identification information of the application to produce a portable affinity record at the origin datacenter. In addition, the portable affinity record may be transmitted to the destination datacenter from the origin datacenter.

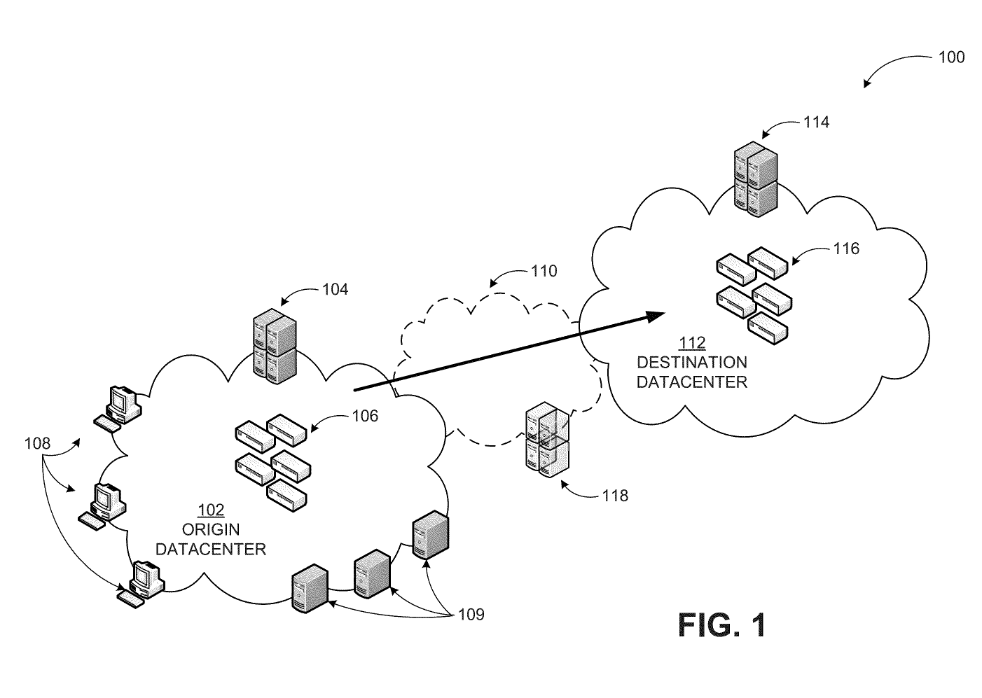

FIG. 1 illustrates example origin and destination datacenters that may exchange microarchitecture attributes of an application, arranged in accordance with at least some embodiments described herein.

As shown in a diagram 100, a network 110 may facilitate communication of microarchitecture attributes of an application being executed or being executed at an origin datacenter 102 to a destination datacenter 112. The origin datacenter 102 may include multiple components. For example, as depicted, the components may include a server cluster 104, storage devices 106, client devices 108, and servers 109. The storage devices 106 may include devices dedicated to storage of data. Such devices may include hard disk drive (HDD) based devices, solid state drive (SSD) based devices, devices hosting both SSD and HDD combinations, controllers, managers, and other storage technology based devices. The servers 109 may provide applications and services to access the data stored by the storage devices 106. The server cluster 104 may be used to provide computing intensive services such as data mining and similar ones associated with the data stored in the storage devices 106. The client devices 108 may be allowed access to data, services, and applications offered by the origin datacenter 102.

The destination datacenter 112 may include a server cluster 114 and storage devices 116. Similar to the origin datacenter 102, the destination datacenter 112 may store data in the storage devices 116. The server cluster 114 may be used to provide computing intensive services or other applications and services based on configuration of the server cluster 114. A service may be an application executed or being executed at a remote device, which may provide functionality using the service through a network access to the client devices.

The origin datacenter 102 may communicate microarchitecture attributes of an application executed or being executed at the origin datacenter 102 to the destination datacenter 112 through the network 110. The network 110 may include wired and wireless components. The network 110 may be managed by servers 118 monitoring and maintaining resources available at the network 110 including network bandwidth and network traffic.

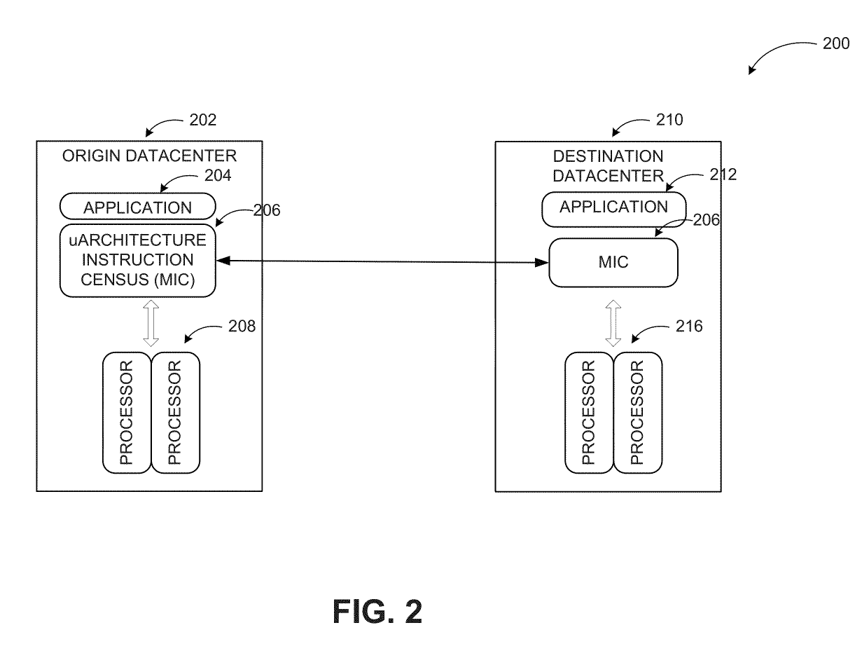

FIG. 2 illustrates an example schema of communicating microarchitecture attributes of an application between datacenters, arranged in accordance with at least some embodiments described herein.

As shown in a diagram 200, an origin datacenter 202 and a destination datacenter 210 may communicate microarchitecture attributes of an application executed or being executed in the origin datacenter 202, through a distributed broker. The distributed broker may be a distributed application. One or more components of the distributed broker may be executed in the origin datacenter 202 and the destination datacenter 210 in order to communicate the microarchitecture attributes of an application 204. The components of the distributed broker may read event counter registers of processors 208 during execution of the application 204 at the origin datacenter 202 in order to collect microarchitecture instructions associated with the application 204. The microarchitecture instructions may be collected into a MIC 206.

The MIC 206 may be transmitted to the destination datacenter 210 by the component of the distributed broker being executed at the origin datacenter 202. Another component of the distributed broker may process the MIC 206 through an affinity analysis at the destination datacenter 210 to determine an affinity between the application 204 and one or more processors at the destination datacenter 210. The affinity may include micro-architecture attributes such as power settings, a power instructions set, a microarchitecture instruction set, and similar ones. Based on the affinity analysis, the distributed broker may select processors 216 matching the MIC 206 data. Next, the distributed broker may execute the application 212 at the processors 216 matching the MIC 206. Alternatively, the distributed broker may allow the destination datacenter 210 to execute the application 212 on the processors 216. The application 212 may be a copy of the application 204, executed or being executed at the destination datacenter 210.

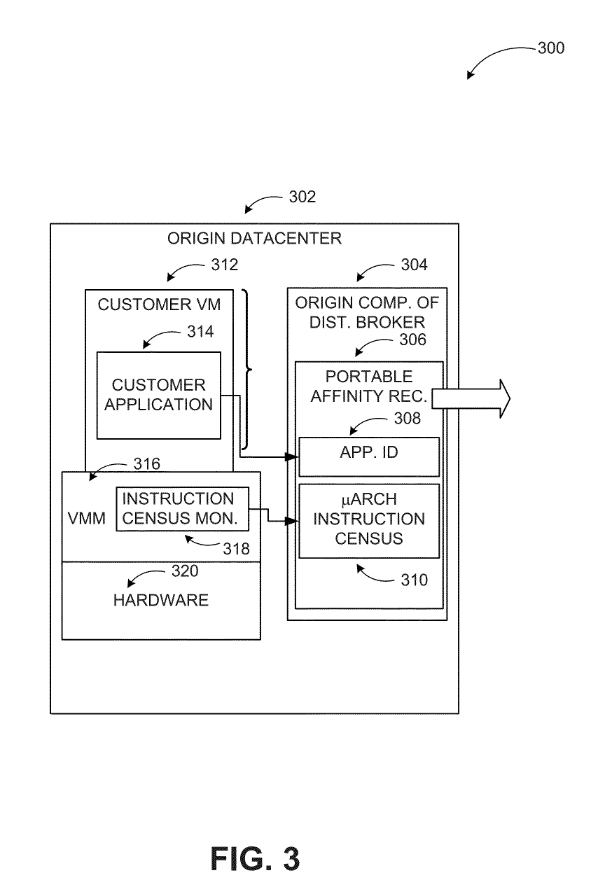

FIG. 3 illustrates an example origin datacenter configured to communicate microarchitecture attributes of an application, arranged in accordance with at least some embodiments described herein.

As shown in a diagram 300, components of an origin datacenter 302 may communicate microarchitecture attributes of an application to a destination datacenter through a distributed broker. The origin datacenter 302 may be executing a customer virtual machine (VM) 312. The customer VM 312 may be a self-contained application execution environment allowing a customer to execute applications within a shared resource such as the origin datacenter 302. The customer may include a consumer, a user, and similar ones. An example may include a customer application 314 that may be executed or being executed within the customer VM 312 or any other form of containerization, sandboxing, or isolation. A VM manager (VMM) 316 may record microarchitecture instruction data associated with the application 314 within event counter registers of hardware 320. The event counter registers may store instructions associated with processors of the origin datacenter 302. The hardware 320 may include the processors. In some examples, counting may be done by the privileged access and observation of the VMM. In other examples, the census may count individual instructions. In yet other examples, the census may count n-grams of instructions such as di-grams or tri-grams recording the occurrence of series' of instructions.

The origin component of a distributed broker 304 being executed in the origin datacenter 302 may collect the instruction data monitored by an instruction census monitor 318 within a MIC 310. The distributed broker may also store an identification information 308 of the application 314. The distributed broker 304 may associate the MIC 310 with the identification information 308 and generate a portable affinity record 306. The portable affinity record 306 may represent an affinity of the application 314 to attributes of a microarchitecture. The portable affinity record 306 may be transmitted to a destination datacenter to allow the destination datacenter to execute a copy of the application 314. The component of the distributed broker 304 may allow the destination datacenter to execute the copy of the application 314 by identifying processors at the destination datacenter having attributes matching the microarchitecture attributes described in the portable affinity record. The microarchitecture attributes may include power settings, power instruction set, microarchitecture instruction set, and similar ones.

In addition, the origin component of the distributed broker 304 may add subsequent instruction counters of the application 314 such as read from a set of event counter registers of the origin datacenter 302 to the MIC 310. Power consumption of an event associated with the application 314 may be determined in order to store in the MIC 310 by reading the event counter register associated with a set of event counter registers used by processor cores of the origin datacenter 302 executing the application 314. Furthermore, retired calls related to branch events, cache hits, cache misses, and monitored instructions associated with the application 314 may be counted by using the event counter register in order to store in the MIC 310.

The MIC 310 may also be converted to instruction per cycle (IPC) values by the distributed broker 304 for transmission to the destination datacenter within the portable affinity record 306. The component of the distributed broker executing in the destination datacenter may process the IPC values through an affinity analysis to match attributes of processors at the destination datacenter to microarchitecture attributes described by the IPC values. The MIC 310 may be converted to IPC values by recording a start time associated with a start of a census period associated with the MIC, starting the census period, and recording an end time associated with an end of the census period. In addition, the IPC values may be computed from the start time, the end time, and the MIC 310.

Furthermore, the portable affinity record may be produced by using a task (executed or being executed at the origin datacenter 302) and an identification information of the task in place of the application and the identification information 308 of the application. Alternatively, the portable affinity record may be produced by using a task associated with the application 314 and an identification information of the task in addition to the application 314 and the identification information 308 of the application. In addition, a customer or another broker may be allowed to transmit the portable affinity record 306 to the destination datacenter. And, the MIC 310 may be generated and produced by using a plug-in or a built-in application programming interface (API). The plug-in or built-in API may be produced based on third party demands in order to sell the plug-in or built-in API.

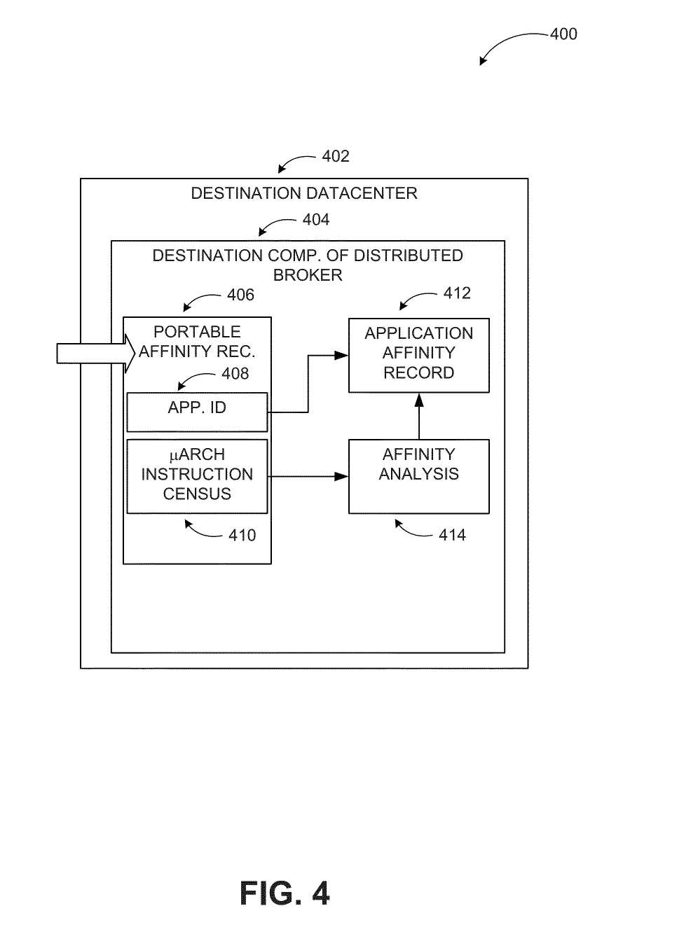

FIG. 4 illustrates an example destination datacenter configured to receive microarchitecture attributes of an application, arranged in accordance with at least some embodiments described herein.

As shown in a diagram 400, a destination datacenter 402 may execute a destination component of a distributed broker 404. The distributed broker 404 may generate an application affinity record 412 to match processors of the destination datacenter 402 to an application based on the application affinity record 412. The application may be a copy of the application executed or being executed at a destination datacenter.

A portable affinity record 406 may be analyzed to determine an identification information 408 associated with the application executed or being executed at the origin datacenter. A MIC 410 associated with the identification information 408 may also be determined from the portable affinity record 406. The MIC 410 may be processed through an affinity analysis 414 to determine matching processors at the destination datacenter 402. The affinity analysis may match attributes such as power settings, power instruction sets, microarchitecture instructions sets, branch predictors, caches, speculative execution units, processing capabilities, and similar ones associated with the processors of the destination datacenter 402 to attributes described in the MIC 410. Matching processors at the destination datacenter may be selected. References to the selected processors may be stored in the affinity analysis 414. Results of the affinity analysis 414 may be combined with the identification information 408 of the application to produce the application affinity record 412.

The application affinity record 412 may be used to execute a copy of the application at the origin datacenter at the destination datacenter. A component of the distributed broker 404 may determine the selected processors from the application affinity record 412. The distributed broker 404 may execute the copy of the application at the selected processors. Alternatively, the distributed broker 404 may provide application affinity record 412 to the destination datacenter 402 to allow the destination datacenter 402 to execute a copy of the application. The selected processors as defined in the application affinity record 412 may be used to execute the copy of the application. In addition, the identification information 408 of the application may be any type of identification including, but not exclusive to, an application serial number, a process identifier, a customer identifier associated with the application, and similar ones.

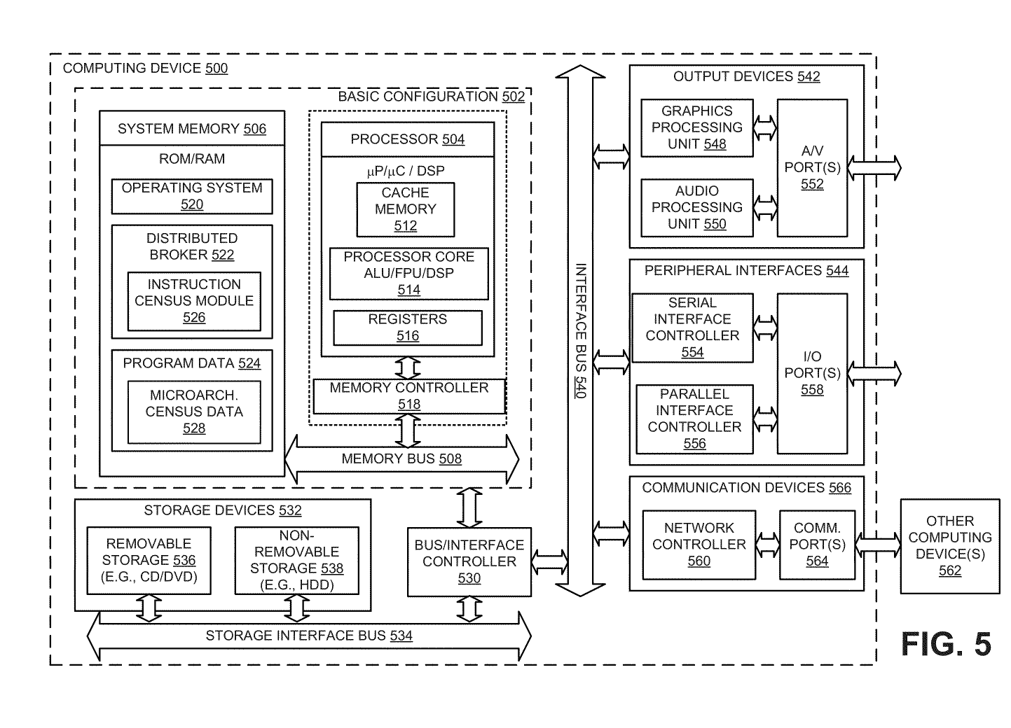

FIG. 5 illustrates a general purpose computing device, which may be used to communicate microarchitecture attributes of an application between datacenters, arranged in accordance with at least some embodiments described herein. The computing device 500 of the FIG. 5, may be one or more of the origin datacenter 102, 202, 302 and destination datacenter 112, 210, 402, or some other device that is not shown in FIGS. 1, 2, 3, and 4. In a very basic configuration 502, computing device 500 typically includes one or more processors 504 and a system memory 506. A memory bus 508 may be used for communicating between processor 504 and system memory 506.

Depending on a particular configuration, processor 504 may be of any type including but not limited to a microprocessor (μP), a microcontroller (μC), a Digital Signal Processor (DSP), or any combination thereof. Processor 504 may include one more levels of caching, such as a level cache memory 512, a processor core 514, and registers 516. Example processor core 514 may include an Arithmetic Logic Unit (ALU), a floating point unit (FPU), a Digital Signal Processing core (DSP Core), or any combination thereof. An example memory controller 518 may also be used with processor 504, or in some implementations, memory controller 514 may be an internal part of processor 504.

Depending on the particular configuration, system memory 506 may be of any type including but not limited to volatile memory (such as RAM), non-volatile memory (such as ROM, flash memory, etc.) or any combination thereof. System memory 506 may include an operating system 520, one or more distributed broker 522, and program data 524. The distributed broker 522 may include an instruction census module 526 that is arranged to provide communication of application microarchitecture attributes between datacenters. Program data 524 may include or more of microarchitecture census data 528 and similar data as discussed above in conjunction with at least FIGS. 1, 2, 3, and 4. This data may be useful for communicating microarchitecture attributes of an application between datacenters as is described herein. This described basic configuration 502 is illustrated in FIG. 5 by those components within the inner dashed line.

Computing device 500 may have additional features or functionality, and additional interfaces to facilitate communications between basic configuration 502 and any required devices and interfaces. For example, a bus/interface controller 530 may be used to facilitate communications between basic configuration 502 and one or more data storage devices 532 via a storage interface bus 534. Data storage devices 532 may be removable storage devices 536, non-removable storage devices 538, or a combination thereof. Examples of removable storage and non-removable storage devices include magnetic disk devices such as flexible disk drives and Hard-Disk Drives (HDDs), optical disk drives such as Compact Disk (CD) drives or Digital Versatile Disk (DVD) drives, Solid State Drives (SSDs), and tape drives to name a few. Example computer storage media may include volatile and nonvolatile, removable and non-removable media implemented in any method or technology for storage of information, such as computer readable instructions, data structures, program modules, or other data.

System memory 506, removable storage devices 536 and non-removable storage devices 538 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store information and which may be accessed by computing device 500. Any such computer storage media may be part of computing device 500.

Computing device 500 may also include an interface bus 540 for facilitating communication from various interface devices (for example, output devices 542, peripheral interfaces 544, and communication devices 566 to basic configuration 502 via bus/interface controller 530. Example output devices 542 include a graphics processing unit 548 and an audio processing unit 540, which may be configured to communicate to various external devices such as a display or speakers via one or more A/V ports 542. Example peripheral interfaces 544 include a serial interface controller 544 or a parallel interface controller 546, which may be configured to communicate with external devices such as input devices (for example, keyboard, mouse, pen, voice input device, touch input device, etc.) or other peripheral devices (for example, printer, scanner, etc.) via one or more I/O ports 548. An example communication device 566 includes a network controller 560, which may be arranged to facilitate communications with one or more other computing devices 562 over a network communication link via one or more communication ports 564.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 500 may be implemented as a portion of a physical server, virtual server, a computing cloud, or a hybrid device that include any of the above functions. Computing device 500 may also be implemented as a personal computer including both laptop computer and non-laptop computer configurations. Moreover, computing device 500 may be implemented as a networked system or as part of a general purpose or specialized server.

Networks for a networked system including computing device 500 may comprise any topology of servers, clients, switches, routers, modems, Internet service providers, and any appropriate communication media (for example, wired or wireless communications). A system according to embodiments may have a static or dynamic network topology. The networks may include a secure network such as an enterprise network (for example, a LAN, WAN, or WLAN), an unsecure network such as a wireless open network (for example, IEEE. 802.11 wireless networks), or a world-wide network such (for example, the Internet). The networks may also comprise a plurality of distinct networks that are adapted to operate together. Such networks are configured to provide communication between the nodes described herein. By way of example, and not limitation, these networks may include wireless media such as acoustic, RF, infrared and other wireless media. Furthermore, the networks may be portions of the same network or separate networks.

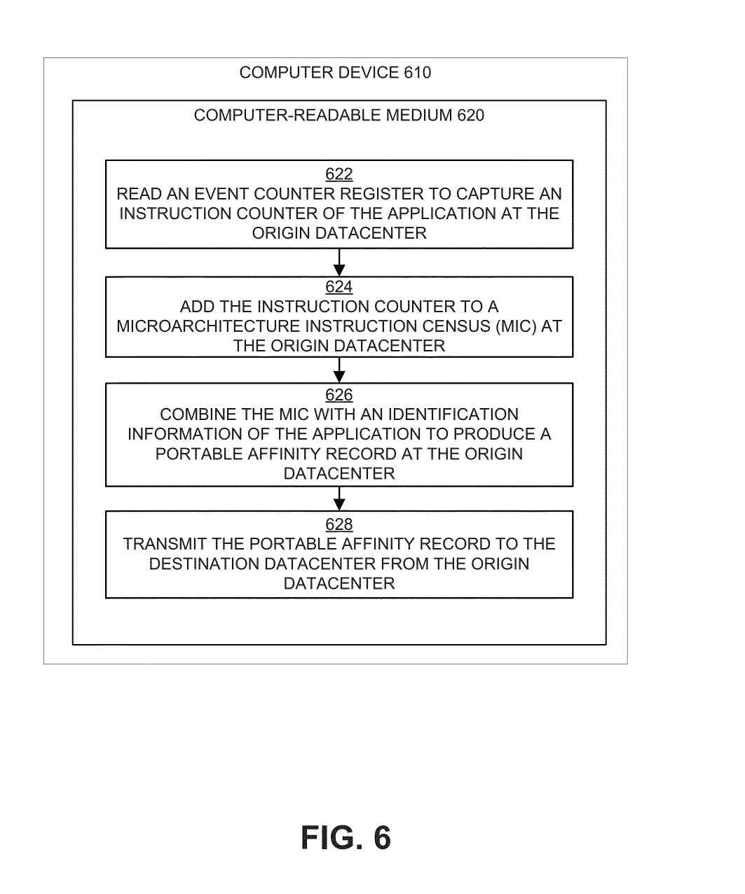

FIG. 6 is a flow diagram illustrating an example method to communicate microarchitecture attributes of an application that may be performed by a computing device 610, such as the computing device 500 in FIG. 5, arranged in accordance with at least some embodiments described herein.

The computing device 610 may be embodied as computing device 500, or similar devices executing instructions stored in a non-transitory computer-readable medium 620 for performing the method. A process to communicate microarchitecture attributes of an application between datacenters may include one or more operations, functions or actions as is illustrated by one or more of blocks 622, 624, 626, and/or 628.

Some example processes may begin with an operation 622, “READ AN EVENT COUNTER REGISTER TO CAPTURE AN INSTRUCTION COUNTER OF THE APPLICATION AT THE ORIGIN DATACENTER.” At operation 622, the computing device 500 may read the event instruction counter to collect microarchitecture instructions associated with the application 204.

The operation 622 may be followed by an operation 624, “ADD THE INSTRUCTION COUNTER TO A MICROARCHITECTURE INSTRUCTION CENSUS (MIC) AT THE ORIGIN DATACENTER.” At operation 624, the computing device 500 may convert to instruction per cycle (IPC) values at the origin datacenter 302, add the counter value directly, or otherwise add a value based on observed values as described above.

The operation 624 may be followed by an operation 626, “COMBINE THE MIC WITH AN IDENTIFICATION INFORMATION OF THE APPLICATION TO PRODUCE A PORTABLE AFFINITY RECORD AT THE ORIGIN DATACENTER.” At operation 626, the computing device 500 may produce the portable affinity record 306 by using the application 204 or a task and an identification information of the application 204 or the task.

The operation 626 may be followed by an operation 628, “TRANSMIT THE PORTABLE AFFINITY RECORD TO THE DESTINATION DATACENTER FROM THE ORIGIN DATACENTER.” At operation 628, the computing device 500 may allow a customer or another broker to transmit the portable affinity record 306 to the destination datacenter 402.

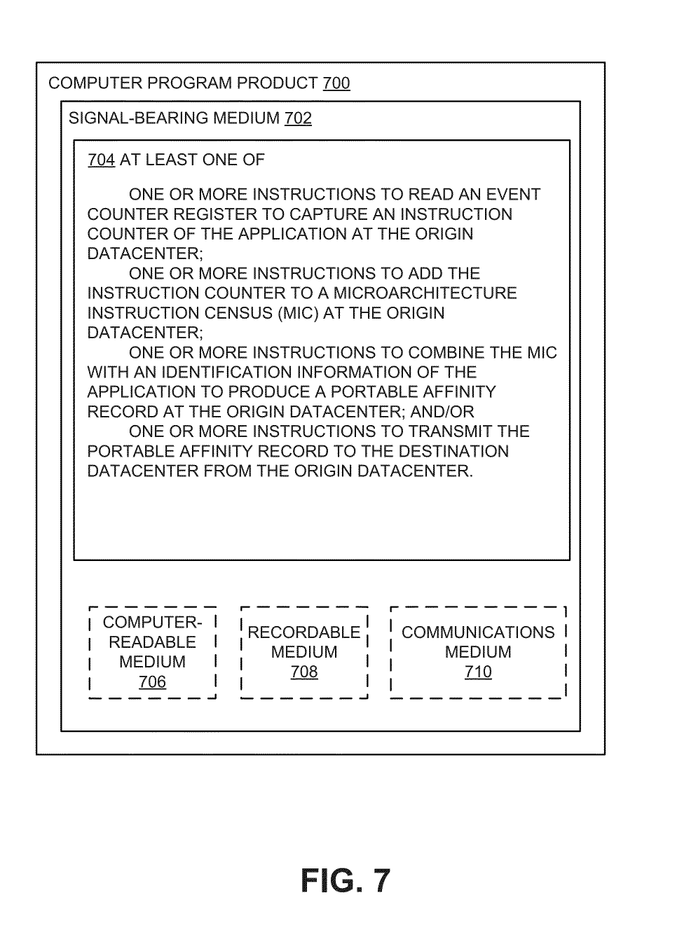

FIG. 7 illustrates a block diagram of an example computer program product to communicate microarchitecture attributes of an application, arranged in accordance with at least some embodiments described herein.

In some examples as shown in FIG. 7, computer program product 700 may include a signal bearing medium 702 that may also include machine readable instructions 704 that, in response to execution by, for example, a processor, may provide the functionality described above with respect to FIG. 1 through FIG. 6. Thus, for example, referring to computing device 500, one or more of the tasks shown in FIG. 7 may be undertaken in response to instructions 704 conveyed to the computing device 500 by medium 702 to perform actions associated with the instructions 704 conveyed to the computing device 500 by the medium 702 to perform actions associated with communication of application microarchitecture attributes between datacenters. Some of those instructions may include reading an event counter register to capture an instruction counter of the application, adding the instruction counter to a microarchitecture instruction census (MIC), combining the MIC with an identification information of the application to produce a portable affinity record, and transmitting the portable affinity record to the destination datacenter.

In some implementations, signal bearing medium 702 depicted in FIG. 7 may encompass a non-transitory computer-readable medium 706, such as, but not limited to, a hard disk drive, a Compact Disc (CD), a Digital Versatile Disk (DVD), a digital tape, memory, etc. In some implementations, signal bearing medium 702 may encompass a recordable medium 708, such as, but not limited to, memory, read/write (R/W) CDs, R/W DVDs, etc. In some implementations, signal bearing medium 702 may encompass a communications medium 710, such as, but not limited to, a digital and/or an analog communication medium (for example, a fiber optic cable, a waveguide, a wired communications link, a wireless communication link, etc.). Thus, for example, computer program product 700 may be conveyed to the processor 704 by an RF signal bearing medium 702, where the signal bearing medium 702 is conveyed by a wireless communications medium 710 (for example, a wireless communications medium conforming with the IEEE 802.11 standard).

According to some examples, a method is provided to communicate microarchitecture attributes of an application executed at an origin datacenter to a destination datacenter. An example method may include reading an event counter register to capture an instruction counter of the application, adding the instruction counter to a microarchitecture instruction census (MIC), combining the MIC with an identification information of the application to produce a portable affinity record, and transmitting the portable affinity record to the destination datacenter.

According to other examples, the method may further include adding subsequent instruction counters of the application read from a set of event counter registers of the origin datacenter to the MIC. Counts of n-grams of instructions may be added into the MIC at the origin datacenter, where the n-grams include at least one of di-grams and tri-grams of the instructions recording an occurrence of the instructions. One or more retired call related to one or more branch event associated with the application may be counted by using the event counter register.

According to further examples, the method may further include converting the MIC to one or more instruction per cycle (IPC) value. A start time associated with a start of a census period associated with the MIC may be recorded. The census period may be started. An end time associated with an end of the census period may be recorded. In addition, the one or more IPC value may be recorded from the start time, the end time, and the MIC.

According to yet further examples, the method may further include producing the portable affinity record by using a task and an identification information of the task in place of the application and the identification information of the application. The portable affinity record may be produced by using a task associated with the application and an identification information of the task in addition to the application and the identification information of the application. One or more of a customer and a broker may be allowed to transmit the portable affinity record to the destination datacenter. The MIC may be generated by using one of: a plug-in and a built-in application programming interface (API). In addition, the portable affinity record may be produced by using one of: the plug-in and the built-in API.

According to other examples, a method is provided to communicate microarchitecture attributes of an application executed at an origin datacenter to a destination datacenter. An example method may include receiving a portable affinity record from the origin datacenter, generating a destination affinity record of an affinity between an identification information of an application and hardware resources based on a microarchitecture instruction census (MIC) in the portable affinity record, and processing the MIC associated with the portable affinity record through an affinity analysis to generate the destination affinity record.

According to other examples, a method is provided to communicate microarchitecture attributes of an application executed at an origin datacenter to a destination datacenter through a distributed broker. An example method may include reading an event counter register to capture an instruction counter of the application at the origin datacenter, adding the instruction counter to a microarchitecture instruction census (MIC) at the origin datacenter, combining the MIC with an identification information of the application to produce a portable affinity record at the origin datacenter, transmitting the portable affinity record to the destination datacenter from the origin datacenter, receiving the portable affinity record at the destination datacenter, generating a destination affinity record of an affinity between an identification information of an application and hardware resources based on the MIC in the portable affinity record at the destination datacenter, and processing the MIC associated with the portable affinity record through an affinity analysis to generate the destination affinity record at the destination datacenter.

According to further examples, the method may further include adding subsequent instruction counters of the application read from a set of event counter registers of the origin datacenter to the MIC at the origin datacenter, counting one or more retired call related to one or more branch event associated with the application by using the event counter register at the origin datacenter, and adding counts of n-grams of instructions into the MIC at the origin datacenter, where the n-grams include at least one of di-grams and tri-grams of the instructions recording an occurrence of the instructions. The MIC may be converted to one or more instruction per cycle (IPC) value at the origin datacenter by recording a start time associated with a start of a census period associated with the MIC at the origin datacenter, starting the census period at the origin datacenter, recording an end time associated with an end of the census period at the origin datacenter, and computing the one or more IPC value from the start time, the end time, and the MIC at the origin datacenter.

According to some examples, the method may further include producing the portable affinity record by using a task and an identification information of the task in place of the application and the identification information of the application at the origin datacenter, and allowing one or more of: a customer and a broker to transmit the portable affinity record to the destination datacenter at the origin datacenter. The MIC may be generated by using one of: a plug-in and a built-in application programming interface (API) at the origin datacenter, the portable affinity record may be produced by using one of: the plug-in and the built-in API at the origin datacenter, and the portable affinity record may be produced by using a task associated with the application and an identification information of the task in addition to the application and the identification information of the application at the origin datacenter.

According to other examples, a device is provided to communicate microarchitecture attributes of an application executed at an origin datacenter to a destination datacenter through a distributed broker. The device may include the origin datacenter, the destination datacenter, a memory configured to store instructions, and a controller coupled to the memory and configured to execute an instruction census module of the distributed broker. The instruction census module may be configured to read an event counter register to capture an instruction counter of the application at the origin datacenter, add the instruction counter to a microarchitecture instruction census (MIC) at the origin datacenter, combine the MIC with an identification information of the application to produce a portable affinity record at the origin datacenter, transmit the portable affinity record to the destination datacenter from the origin datacenter, receive the portable affinity record at the destination datacenter, generate a destination affinity record of an affinity between an identification information of an application and hardware resources based on the MIC in the portable affinity record at the destination datacenter, and process the MIC associated with the portable affinity record through an affinity analysis to generate the destination affinity record at the destination datacenter.

According to some examples, the instruction census module may be further configured to add subsequent instruction counters of the application read from a set of event counter registers of the origin datacenter to the MIC at the origin datacenter, count one or more retired call related to one or more branch event associated with the application by using the event counter register at the origin datacenter, and add counts of n-grams of instructions into the MIC at the origin datacenter, where the n-grams include at least one of di-grams and tri-grams of the instructions recording an occurrence of the instructions. The MIC may be converted to one or more instruction per cycle (IPC) value at the origin datacenter through a process to record a start time associated with a start of a census period associated with the MIC at the origin datacenter, start the census period at the origin datacenter, record an end time associated with an end of the census period at the origin datacenter, and compute the one or more IPC value from the start time, the end time, and the MIC at the origin datacenter.

According to further examples, the instruction census module may be further configured to produce the portable affinity record by using a task and an identification information of the task in place of the application and the identification information of the application at the origin datacenter and allow one or more of; a customer and a broker to transmit the portable affinity record to the destination datacenter at the origin datacenter. The MIC may be generated by using one of a plug-in and a built-in application programming interface (API) at the origin datacenter, the portable affinity record may be produced by using one of; the plug-in and the built-in API at the origin datacenter, and the portable affinity record may be produced by using a task associated with the application and an identification information of the task in addition to the application and the identification information of the application at the origin datacenter.

According to other examples, a computer-readable medium may be provided to communicate microarchitecture attributes of an application executed at an origin datacenter to a destination datacenter through a distributed broker. The instructions may cause a method to be performed in response to execution, the method being similar to the methods described above.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be well within the skill of one of skill in the art in light of this disclosure.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.),

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that atypical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”) the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method to communicate microarchitecture attributes of an application executed at an origin datacenter to a destination datacenter, the method comprising:
reading an event counter register to capture an instruction counter of the application;
adding the instruction counter to a microarchitecture instruction census (MIC);
combining the MIC with an identification information of the application to produce a portable affinity record; and
transmitting the portable affinity record to the destination datacenter.

2. The method of claim 1, further comprising adding subsequent instruction counters of the application read from a set of event counter registers of the origin datacenter to the MIC.

3. The method of claim 1, further comprising adding counts of n-grams of instructions into the MIC at the origin datacenter, wherein the n-grams include at least one of di-grams and tri-grams of the instructions recording an occurrence of the instructions.

4. The method of claim 1, further comprising counting at least one retired call related to at least one branch event associated with the application by using the event counter register.

5. The method of claim 1, further comprising converting the MIC to at least one instruction per cycle (IPC) value.

6. The method of claim 5, further comprising:
recording a start time associated with a start of a census period associated with the MIC;
starting the census period;
recording an end time associated with an end of the census period; and
computing the at least one IPC value from the start time, the end time, and the MIC.

7. The method of claim 1, further comprising:
producing the portable affinity record by using a task and an identification information of the task in place of the application and the identification information of the application.

8. The method of claim 1, further comprising:
producing the portable affinity record by using a task associated with the application and an identification information of the task in addition to the application and the identification information of the application.

9. The method of claim 1, further comprising:
allowing at least one of: a customer and a broker to transmit the portable affinity record to the destination datacenter.

10. The method of claim 1, further comprising:
generating the MIC by using one of: a plug-in and a built-in application programming interface (API); and
producing the portable affinity record by using one of: the plug-in and the built-in API.

11.-16. (canceled)

17. A device to communicate microarchitecture attributes of an application executed at an origin datacenter to a destination datacenter through a distributed broker, the device comprising:
the origin datacenter;
the destination datacenter;
a memory configured to store instructions; and
a controller coupled to the memory and configured to execute an instruction census module of the distributed broker, wherein the instruction census module is configured to:
read an event counter register to capture an instruction counter of the application at the origin datacenter;
add the instruction counter to a microarchitecture instruction census (MIC) at the origin datacenter;
combine the MIC with an identification information of the application to produce a portable affinity record at the origin datacenter;
transmit the portable affinity record to the destination datacenter from the origin datacenter;
receive the portable affinity record at the destination datacenter;
generate a destination affinity record of an affinity between an identification information of an application and hardware resources based on the MIC in the portable affinity record at the destination datacenter; and
process the MIC associated with the portable affinity record through an affinity analysis to generate the destination affinity record at the destination datacenter.

18. The device according to claim 17, wherein the instruction census module is further configured to:
add subsequent instruction counters of the application read from a set of event counter registers of the origin datacenter to the MIC at the origin datacenter;
count at least one retired call related to at least one branch event associated with the application by using the event counter register at the origin datacenter; and
add counts of n-grams of instructions into the MIC at the origin datacenter, wherein the n-grams include at least one of di-grams and tri-grams of the instructions recording an occurrence of the instructions.

19. The device according to claim 17, wherein the instruction census module is further configured to:
convert the MIC to at least one instruction per cycle (IPC) value at the origin datacenter through a process to:
record a start time associated with a start of a census period associated with the MIC at the origin datacenter;
start the census period at the origin datacenter;
record an end time associated with an end of the census period at the origin datacenter; and
compute the at least one IPC value from the start time, the end time, and the MIC at the origin datacenter.

20. The device according to claim 17, wherein the instruction census module is further configured to:
produce the portable affinity record by using a task and an identification information of the task in place of the application and the identification information of the application at the origin datacenter; and
allow at least one of: a customer and a broker to transmit the portable affinity record to the destination datacenter at the origin datacenter.

21. The device according to claim 17, wherein the instruction census module is further configured to:
generate the MIC by using one of: a plug-in and a built-in application programming interface (API) at the origin datacenter;
produce the portable affinity record by using one of: the plug-in and the built-in API at the origin datacenter; and
produce the portable affinity record by using a task associated with the application and an identification information of the task in addition to the application and the identification information of the application at the origin datacenter.

22. A computer-readable storage medium with instructions stored thereon to communicate microarchitecture attributes of an application executed at an origin datacenter to a destination datacenter through a distributed broker, the instructions in response to execution cause a method to be performed, wherein the method comprises:
reading an event counter register to capture an instruction counter of the application at the origin datacenter;
adding the instruction counter to a microarchitecture instruction census (MIC) at the origin datacenter;
combining the MIC with an identification information of the application to produce a portable affinity record at the origin datacenter;
transmitting the portable affinity record to the destination datacenter from the origin datacenter;
receiving the portable affinity record at the destination datacenter;
generating a destination affinity record of an affinity between an identification information of an application and hardware resources based on the MIC in the portable affinity record at the destination datacenter; and
processing the MIC associated with the portable affinity record through an affinity analysis to generate the destination affinity record at the destination datacenter.

23. The computer-readable storage medium according to claim 22, wherein subsequent instruction counters of the application read from a set of event counter registers of the origin datacenter are added to the MIC at the origin datacenter, at least one retired call related to at least one branch event associated with the application is counted by using the event counter register at the origin datacenter, and counts of n-grams of instructions are added into the MIC, wherein the n-grams include at least one of di-grams and tri-grams of the instructions recording an occurrence of the instructions.

24. The computer-readable storage medium according to claim 22, wherein the MIC to at least one instruction per cycle (IPC) value is converted at the origin datacenter by recording a start time associated with a start of a census period associated with the MIC at the origin datacenter, starting the census period at the origin datacenter, recording an end time associated with an end of the census period at the origin datacenter, and computing the at least one IPC value from the start time, the end time, and the MIC at the origin datacenter.

25. The computer-readable storage medium according to claim 22, wherein the portable affinity record is produced by using a task and an identification information of the task in place of the application and the identification information of the application at the origin datacenter and a customer is allowed to transmit the portable affinity record to the destination datacenter at the origin datacenter.

26. The computer-readable storage medium according to claim 22, wherein the MIC is generated by using one of: a plug-in and a built-in application programming interface (API) at the origin datacenter, the portable affinity record is produced by using one of: the plug-in and the built-in API at the origin datacenter, and the portable affinity record is produced by using a task associated with the application and an identification information of the task in addition to the application and the identification information of the application at the origin datacenter.
